(19) United States
(12) Patent Application Publication
(10) Pub. No.: US 2021/0256892 A1
(43) Pub. Date: Aug. 19, 2021

(54) DISPLAY DEVICE

(71) Applicant: SAMSUNG DISPLAY CO., LTD., Yongin-si (KR)

(72) Inventor: Byeong Doo KANG, Yongin-si (KR)

(21) Appl. No.: 17/028,255

(22) Filed: Sep. 22, 2020

(30) Foreign Application Priority Data
Feb. 19, 2020 (KR) 10-2020-0020310

(51) Int. Cl. G09G 3/20; G09G 3/32

(52) U.S. Cl. CPC G09G 3/2003; G09G 2330/025; G09G 2330/04; G09G 3/32

(57) ABSTRACT

A display device according to an embodiment of the disclosure includes a display circuit including pixels divided into a plurality of blocks, a power interface which outputs block currents, a current sensor which senses the block currents and outputs sensing values of the block currents, and a block current controller which outputs a control voltage for controlling a block current supplied to a deterioration block. The power interface includes a plurality of transistors each including a first electrode connected to a first power supply, a second electrode connected to a first power supply line, and a gate electrode connected to a control line.

This application claims priority to Korean Patent Application No. 10-2020-0020310, filed on Feb. 19, 2020, and all the benefits accruing therefrom under 35 U.S.C. §119, the content of which in its entirety is herein incorporated by reference.

### BACKGROUND

### 1. Field

The disclosure relates to a display device.

### 2. Description of the Related Art

As an information technology is developed, the importance of a display device, which is a connection medium between a user and information, is emphasized. Accordingly, the use of a display device such as a liquid crystal display device, an organic light emitting display device, and a plasma display device has been increasing.

The display device may include a plurality of pixels, and each of the plurality of pixels may emit light of various colors and luminances as a current corresponding to a grayscale flows to the pixels, thereby displaying various images.

### SUMMARY

Among images, in a case of an image in which pixels disposed in one area of the display device emit light at a relatively high luminance and pixels disposed in another area of the display device emit light at a relatively low luminance among the pixels, the above-described current may be concentrated to the pixels disposed in any one area. In this case, a relatively high current flows to the pixels disposed in any one area, and thus deterioration may occur in the pixels.

An object of the disclosure is to provide a display device capable of preventing deterioration or a fire phenomenon of pixels due to overcurrent.

Another object of the disclosure is to provide a display device capable of sensing a block current using only a transistor without a separate sensing resistor.

Still another object of the disclosure is to provide a display device capable of reducing manufacturing cost by sensing the block current without adding a separate sensing resistor.

The objects of the disclosure are not limited to the above-described objects, and other technical objects that are not described will be clearly understood by those skilled in the art from the following description.

In order to solve the above-described object, a display device according to an embodiment of the disclosure includes a display circuit including pixels divided into a plurality of blocks, a power interface which outputs block currents corresponding to the blocks to first power supply lines, respectively, based on a voltage of a first power supply and a control voltage, a current sensor which senses the block currents and outputs sensing values of the block currents, and a block current controller which calculates block grayscale values corresponding to the blocks, respectively, based on image data, detects a deterioration block based on the block grayscale values and the sensing values, and outputs the control voltage to a control line for controlling a block current supplied to the deterioration block. The power interface includes a plurality of transistors each including a first electrode connected to the first power supply, a second electrode connected to the first power supply line, and a gate electrode connected to the control line.

In an embodiment, the sensing value may be calculated based on a potential difference between the first electrode and the second electrode of a turned-on transistor and a resistance value of an equivalent resistor of the turned-on transistor.

In an embodiment, when the transistor is turned-on by a reference control voltage of a turn-on level, the resistance value may be calculated based on a potential difference of the equivalent resistor of the turned-on transistor and a block current corresponding to a preset reference block grayscale value.

In an embodiment, a block grayscale value of the deterioration block may be greater than any of block grayscale values of remaining blocks other than the deterioration block in the blocks, and a sensing value obtained from the deterioration block may be greater than sensing values obtained from the remaining blocks.

In an embodiment, a change amount of the block current provided to the deterioration block may be determined based on a change amount of a control voltage applied to a gate electrode of a transistor corresponding to the deterioration block, and the change amount of the control voltage may be calculated based on at least one of a first difference value between the block grayscale value of the deterioration block and any one block grayscale value among the block grayscale values of the remaining blocks, and a second difference value between the sensing value of the deterioration block and any one sensing value among the sensing values of the remaining blocks.

In an embodiment, the any one block grayscale value may be a smallest minimum block grayscale value among the block grayscale values of the remaining blocks, and the any one sensing value may be a smallest minimum sensing value among the sensing values of the remaining blocks.

In an embodiment, the block grayscale value of the deterioration block may be greater than any of block grayscale values of remaining blocks other than the deterioration block in the blocks, and the sensing value obtained from the deterioration block may be greater than a preset reference sensing value.

In an embodiment, a change amount of the block current provided to the deterioration block may be determined based on a change amount of a control voltage applied to a gate electrode of a transistor corresponding to the deterioration block, and the change amount of the control voltage may be calculated based on at least one of a first difference value between the block grayscale value of the deterioration block and any one block grayscale value among the block grayscale values of the remaining blocks, and a second difference value between the sensing value of the deterioration block and the reference sensing value.

In an embodiment, the block current controller may start a detection operation of the deterioration block using a case where a sum of the block grayscale values is equal to or less than a preset reference grayscale value as a start condition.

In an embodiment, the block grayscale value may be any one of a representative value of grayscale values of the respective pixels included in the block, a sum of grayscale values of the respective pixels included in the block, and an average value of the sum of the grayscale values of the respective pixels included in the block.

In an embodiment, the control voltage controlling the block current supplied to the deterioration block may be a voltage of a turn-off level at which a transistor corresponding to the deterioration block is turned-off.

In an embodiment, the power interface may further include a plurality of sensing resistors each having a first terminal connected to the first power supply and a second terminal connected to the first electrode of the transistor.

In an embodiment, the sensing values may be calculated based on a potential difference between a voltage of a node connected to the first power supply and the first terminal and a voltage of a node connected to the first electrode and the second terminal, and a resistance value of the sensing resistor.

In an embodiment, the power interface may further include a plurality of sensing transistors each including a first electrode connected to a second power supply line different from the first power supply line, a second electrode connected to a second power supply having a voltage lower than a voltage of the first power supply, and a gate electrode connected to the control line.

In an embodiment, the sensing transistor may receive a control signal of a turn-off level through the control line and may be turned-off in a sensing period, and a voltage applied to a node to which the second power supply line and the first electrode of the sensing transistor are connected may be higher than the voltage of the first power supply.

A display device according to another embodiment of the disclosure includes a display circuit including pixels divided into a plurality of blocks, a power interface which outputs block currents corresponding to the blocks to first power supply lines, respectively, based on a voltage of first power supply and a control voltage, a current sensor which senses the block currents and output sensing values of the block currents, and a block current controller which calculates block grayscale values corresponding to the blocks, respectively, based on image data, detects a deterioration block based on the block grayscale values and the sensing values, and outputs the control voltage to a control line for controlling a block current supplied to the deterioration block. The power interface includes a plurality of transistors each including a first electrode connected to a second power supply line, a second electrode connected to a second power supply having a voltage lower than the voltage of the first power supply, and a gate electrode connected to the control line.

In an embodiment, the sensing value may be calculated based on a potential difference between the first electrode and the second electrode of a turned-on transistor and a resistance value of an equivalent resistor of the turned-on transistor.

In an embodiment, when the transistor is turned-on by a reference control voltage of a turn-on level, the resistance value may be calculated based on a potential difference between the equivalent resistor of the turned-on transistor and a reference current corresponding to a preset reference block grayscale value.

In an embodiment, a block grayscale value of the deterioration block may be greater than any of block grayscale values of remaining blocks other than the deterioration block in the blocks, and a sensing value obtained from the deterioration block may be greater than any of sensing values obtained from the remaining blocks.

In an embodiment, the block current controller may start a detection operation of the deterioration block using a case where a sum of the block grayscale values is equal to or less than a preset reference grayscale value as a start condition.

In an embodiment, the control voltage controlling the block current supplied to the deterioration block may be a voltage of a turn-off level at which a transistor corresponding to the deterioration block is turned-off.

In an embodiment, the power interface may further include a plurality of sensing resistors each having a first terminal connected to the first power supply and a second terminal connected to the first power supply line.

Details of other embodiments are included in the detailed description and drawings.

As described above, the embodiments of the disclosure provide a display device capable of preventing deterioration or a fire phenomenon of pixels due to overcurrent.

In addition, embodiments of the disclosure may provide a display device capable of sensing a block current using only a transistor without a separate sensing resistor.

In addition, embodiments of the disclosure may provide a display device capable of reducing manufacturing cost by sensing a block current without adding a separate sensing resistor.

Effects according to the embodiments are not limited by the contents illustrated above, more various effects are included in the present specification.

### BRIEF DESCRIPTION OF THE DRAWINGS

The above and other features of the disclosure will become more apparent by describing in further detail embodiments thereof with reference to the accompanying drawings, in which:

FIG. 1 is a diagram schematically illustrating a display device according to an embodiment of the disclosure;

FIG. 2 is a diagram illustrating an embodiment in which pixels included in a display circuit are divided into a plurality of blocks according to an embodiment of the disclosure;

FIGS. 3 and 4 are circuit diagrams for describing a method of driving the pixel according to an embodiment of the disclosure;

FIG. 5 is a diagram for describing an embodiment of a power interface included in the display device shown in FIG. 1;

FIG. 6 is a diagram for describing an embodiment in which a current sensor senses a block current;

FIG. 7 is a diagram for describing an embodiment in which a resistance value of an equivalent resistor of a turned-on transistor is calculated;

FIG. 8 is a diagram for describing an embodiment in which a deterioration block is detected;

FIG. 9 is a diagram for describing embodiments in which the block current supplied to the detected deterioration block is adjusted;

FIG. 10 is a diagram for describing an embodiment of a sensing resistor included in the power interface shown in FIG. 5;

FIG. 11 is a diagram for describing another embodiment in which the current sensor senses the block current;

FIG. 12 is a diagram for describing another embodiment of the power interface included in the display device shown in FIG. 1;

FIG. 13 is a diagram for describing an embodiment of the sensing resistor included in the power interface shown in FIG. 12;

FIG. 14 is a diagram for describing still another embodiment of the power interface included in the display device shown in FIG. 1; and

FIG. 15 is a diagram for describing an embodiment in which the power interface shown in FIG. 14 is driven in a sensing period.

### DETAILED DESCRIPTION

The advantages and features of the disclosure and a method of achieving them will become apparent with reference to the embodiments described in detail below together with the accompanying drawings. However, the disclosure is not limited to the embodiments disclosed below, and may be implemented in various different forms. The present embodiments are provided so that the disclosure will be thorough and complete and those skilled in the art to which the disclosure pertains can fully understand the scope of the disclosure. The disclosure is only defined by the scope of the claims.

In adding reference numerals to components of each drawing, the same components may have the same reference numerals as much as possible even though the same components are shown in different drawings. In addition, in describing the disclosure, when it is determined that the detailed description of the related well-known configuration or function may obscure the gist of the disclosure, the detailed description thereof may be omitted.

In describing the components of the disclosure, terms of first, second, A, B, (a), (b), and the like may be used. These terms are only to distinguish the components from other components, and nature, turn, sequence, number, or the like of the corresponding components is not limited by the terms thereof. In a case where a component is described as being “connected” or “coupled” to another component, the component may be directly connected to or coupled to the other component. However, it will be understood that another component may be “interposed” between each component or each component may be “connected” or “coupled” through another component. A singular form includes a plural form unless the context clearly indicates otherwise. The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

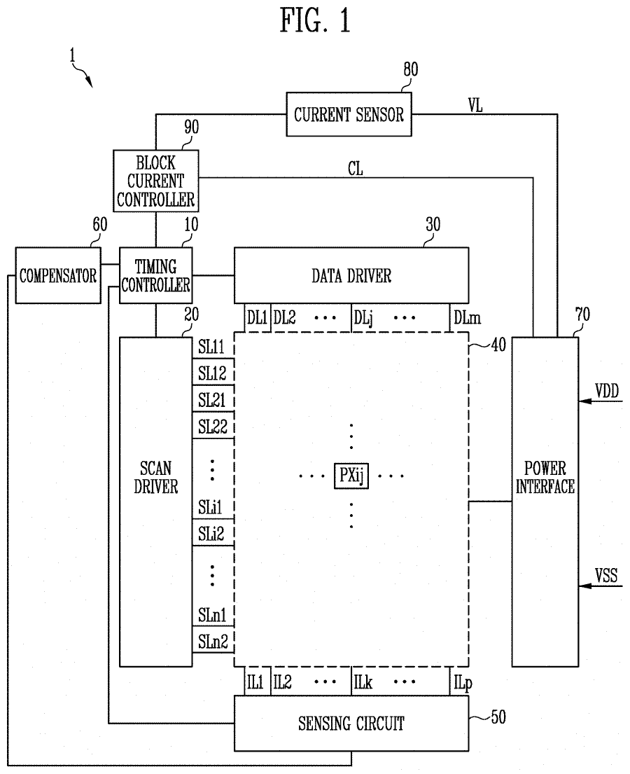

FIG. 1 is a diagram schematically illustrating a display device according to an embodiment of the disclosure.

Referring to FIG. 1, the display device 1 according to an embodiment of the disclosure may include a timing controller 10, a scan driver 20, a data driver 30, a display circuit 40, a sensing circuit 50, a compensator 60, a power interface 70, a current sensor 80, a block current controller 90, and the like.

The timing controller 10 may receive various grayscale values (or grayscale data) and control signals for each image frame from an external processor (not shown). The timing controller 10 may render the grayscale values to correspond to specification of the display device 1. For example, the external processor may provide a red grayscale value, a green grayscale value, and a blue grayscale value for each unit dot. However, for example, when the display circuit 40 is a pentile structure, since adjacent unit dots share a pixel, pixels may not correspond to respective grayscale values one-to-one, and therefore rendering of the grayscale values is required. When the pixels correspond to the respective grayscale values one-to-one, rendering of the grayscale values may not be required. The grayscale values rendered or not rendered may be provided to the data driver 30. The timing controller 10 may provide control signals suitable for each specification to the data driver 30 and the scan driver 20 for displaying a frame. The timing controller 10 may provide control signals suitable for the specification to the sensing circuit 50 to command a sensing operation.

The scan driver 20 may receive clock signals, a scan start signal, and the like from the timing controller 10, and may generate first scan signals to be provided to first scan lines SL11, SL21, SLi1, and SLn1 and second scan signals to be provided to second scan lines SL12, SL22, SLi2, and SLn2, based on the clock signals, the scan start signal, and the like. Here, n may be a natural number and i may be a natural number equal to or less than n.

The scan driver 20 may sequentially supply first scan signals having a pulse of a turn-on level to the first scan lines SL11, SL21, SLi1, and SLn1. In addition, the scan driver 20 may sequentially supply second scan signals having a pulse of a turn-on level to the second scan lines SL12, SL22, SLi2, and SLn2. In this case, pixels PXij are selected by a horizontal line unit (i.e., all pixels in the same row).

Although not shown, the scan driver 20 may include a first scan driver connected to the first scan lines SL11, SL21, SLi1, and SLn1, and a second scan driver connected to the second scan lines SL12, SL22, SLi2, and SLn2. Each of the first scan driver and the second scan driver may include stages configured in a form of a shift register. Each of the first scan driver and the second scan driver may generate the scan signals in a method of sequentially transferring a scan start signal that is a pulse form of a turn-on level to a next stage under control of the clock signals.

According to an embodiment, the first scan signals and the second scan signals may be the same. In this case, a first scan line and a second scan line connected to each pixel PXij may be connected to the same node. In this case, the scan driver 20 may not be divided into a first scan driver and a second scan driver, but may be configured as a single scan driver.

The data driver 30 may generate data voltages to be provided to data lines DL1, DL2, DLj, and DLm using grayscale values and control signals to be synchronized with the scan signal supplied from the scan driver 20. For example, the data driver 30 may sample the grayscale values using a clock signal and apply the data voltages corresponding to the grayscale values to the data lines DL1, DL2, DLj, and DLm by a row unit of pixels. Here, m may be a natural number and j may be a natural number equal to or less than m.

The display circuit 40 may include the pixels PXij. The pixels PXij may be defined by the data lines and the scan lines. That is, each of the pixels PXij may be connected to a corresponding data line, scan line, and sensing line.

Each of the pixels PXij is selected when a scan signal is supplied, charge a voltage corresponding to the data signal, and generate light of a predetermined luminance while supplying a driving current corresponding to the charged voltage to a light emitting diode (not shown).

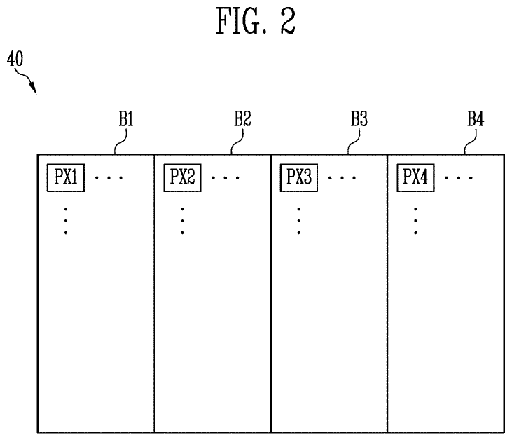

The pixels PXij may be divided into a plurality of blocks, as described later with reference to FIG. 2.

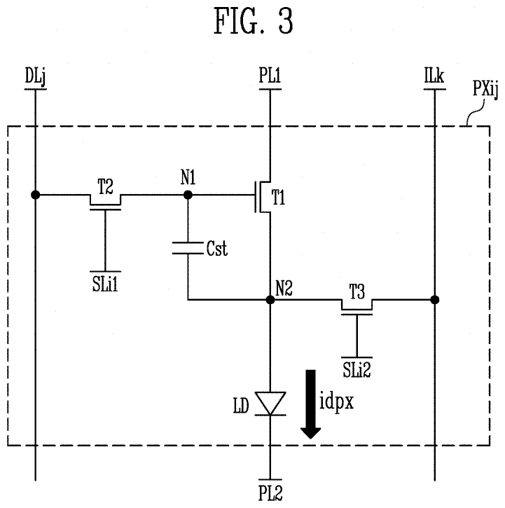

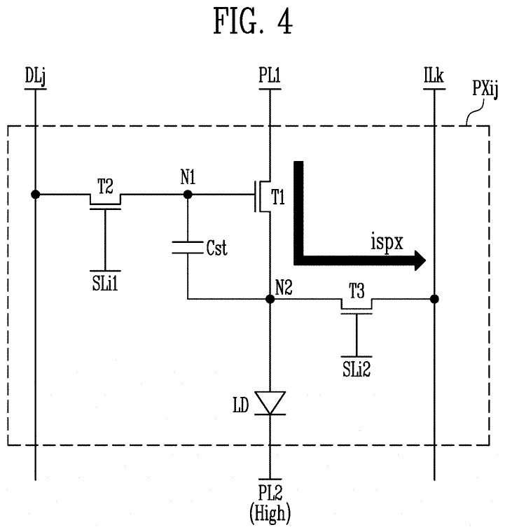

Each of the pixels PXij may be implemented in various circuit structures. As described later with reference to FIGS. 3 and 4, for example, each of the pixels PXij may be implemented in a structure including a first transistor, a second transistor, a third transistor, and a capacitor.

The sensing circuit 50 may receive a control signal from the timing controller 10 and receive a sensing signal through each of sensing lines IL1, IL2, ILk, and ILp. The sensing circuit 50 may be connected to the pixels PXij through the sensing lines IL1, IL2, ILk and ILp. Here, p may be a natural number and may be the same as m described above. In addition, k may be a natural number less than p, and may be the same as j described above.

For example, during the sensing period, the scan driver 20 sequentially supplies the scan signal to the scan lines, the pixels PXij connected to the scan lines are selected in the horizontal line unit (i.e., all pixels in the same row), and the data driver 30 is synchronized with the scan signals to provide a sensing data signal (or a sensing data voltage) for sensing the sensing signal to the data lines DL1, DL2, DLj, and DLm. Next, a sensing current (or a sensing voltage) generated in the selected pixels PXij is generated. Here, the sensing circuit 50 may receive a sensing signal corresponding to the sensing current (or the sensing voltage) through the sensing lines IL1, IL2, ILk, and ILp.

Here, the sensing period may mean, for example, a blank period between the frame and the frame, a predetermined period after the display device 1 is turned-off, or the like. However, the disclosure is not limited thereto.

The sensing circuit 50 may sense the sensing current (or the sensing voltage) and output a sensing value for the sensing current (or the sensing voltage). Here, the sensing value (or sensing data) may mean a sensing current value for the sensing current (or a sensing voltage value for the sensing voltage) as a digital value.

As disclosed in the present embodiment, the data driver 30 and the sensing circuit 50 may be separately configured. However, in another embodiment, the data driver 30 and the sensing circuit 50 may be integrally formed.

Although not shown, the sensing circuit 50 may include sensing channels connected to the sensing lines IL1, IL2, ILk, and ILp. For example, the sensing lines IL1, IL2, ILk, and ILp and the sensing channels may correspond one-to-one.

As disclosed in the present embodiment, the data driver 30 and the sensing circuit 50 may be separately configured. However, in another embodiment, the data driver 30 and the sensing circuit 50 may be integrally formed.

The compensator 60 may calculate a compensation value for each of the pixels PXij based on the sensing value of the sensing circuit 50.

In an embodiment, for example, the compensator 60 may generate an output grayscale value by compensating for an input grayscale value input from the outside using the sensing value output from the sensing circuit 50. The input grayscale value is grayscale data input from an external processor and may mean grayscale data for an image frame. In addition, the output grayscale value may mean grayscale data input to the data driver 30 after compensating the input grayscale value by the compensator 60.

The compensator 60 may include a lookup table (not shown). The lookup table may exist in a data form or may exist in a physical form. In a manufacturing process of the display device 1 of FIG. 1, the lookup table may store compensation amount data corresponding to a sensing value, a change amount of the sensing value, and the like, in advance.

The power interface 70 may receive a voltage of a first power supply VDD and a control voltage (not shown) and output a block current based on the voltage of the first power supply VDD and the control voltage. Here, the control voltage may be a voltage supplied from the block current controller 90 which will be described later.

The block current may be a current flowing through a transistor included in the power interface 70 as described later. Here, the current flowing through the transistor may be a driving current generated in the display period or may be a sensing current generated in the sensing period. However, the disclosure is not limited thereto. When the number of blocks is equal to or greater than two, the number of block currents may also be equal to or greater than two. Although not shown, for example, when the number of blocks is two, the number of block currents may also be two.

The power interface 70 may additionally receive a voltage of a second power supply VSS. In addition, the power interface 70 may output the block current based on the voltage of the first power supply VDD, a voltage of the second power supply VSS, and the control voltage. Here, the voltage of the second power supply VSS may be smaller (or lower) than the voltage of the first power supply VDD. However, in a special situation such as a situation in which light emission of a light emitting diode (not shown) included in the pixel PXij is prevented, the voltage of the second power supply VSS may be set to be greater (or higher) than the voltage of the first power supply VDD.

The current sensor 80 may sense the block current output from the power interface 70 through a measurement line VL and output a sensing value corresponding to the sensed block current. Here, the sensing value may mean a digital value of the sensed block current. Here, the number of the measurement line VL may be one or more, and the plurality of measurement lines VL may be respectively connected to both terminals (or two nodes) of a resistor provided in the power interface 70 as described later.

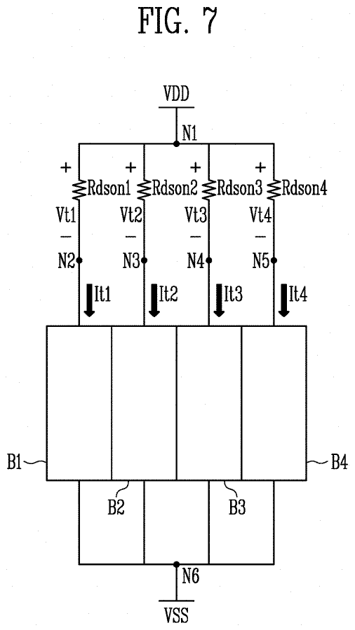

The current sensor 80 may measure a potential difference (i.e., voltage difference) between the both terminals (or two nodes) of the resistor provided in the power interface 70, and sense the block current by using a resistance value and the potential difference of the resistor. For example, the current sensor 80 may calculate the sensing value corresponding to the block current by calculating a ratio of the potential difference to the resistance value of the resistor. Here, the resistor may be a sensing resistor for sensing the block current, and may mean an equivalent resistor of a transistor or the like. Here, the resistance value of the resistor may be defined in a memory in a manufacturing process, or may be actively redefined in a process of using the product. Detailed description thereof will be described later with reference to FIG. 7.

The block current controller 90 may receive image data and calculate block grayscale values corresponding to the block. Here, the block grayscale value may be, for example, a sum of grayscale values for each of pixels included in a specific block. As another example, the block grayscale value may be an average grayscale value of grayscale values for each of the pixels included in a specific block. As still another example, the block grayscale value may be any one representative grayscale value among grayscale values of the pixels included in a specific block.

In an embodiment, for example, in general, since the image data includes grayscale values of the pixels PXij included in the display circuit 40, the block current controller 90 may calculate a sum of the grayscale values of the pixels included in a specific block in the image data, and may calculate a result thereof as a block grayscale value of the specific block.

When the number of blocks is plural, the block current controller 90 may receive the image data and calculate block grayscale values corresponding to the blocks, respectively.

In an embodiment, for example, when the number of blocks is two, the block current controller 90 may receive the image data and calculate a first block grayscale value corresponding to a first block (not shown) and a second block grayscale value corresponding to a second block (not shown), respectively.

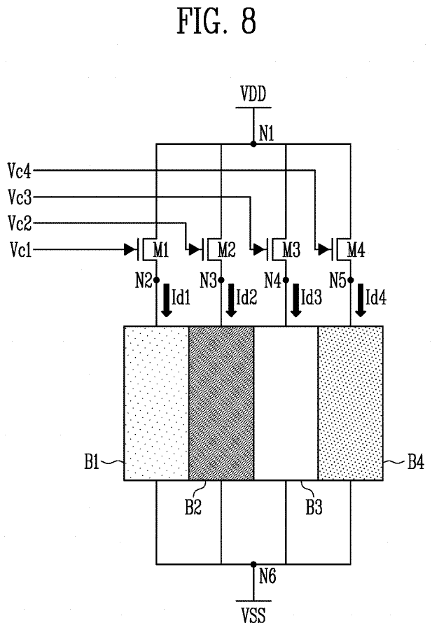

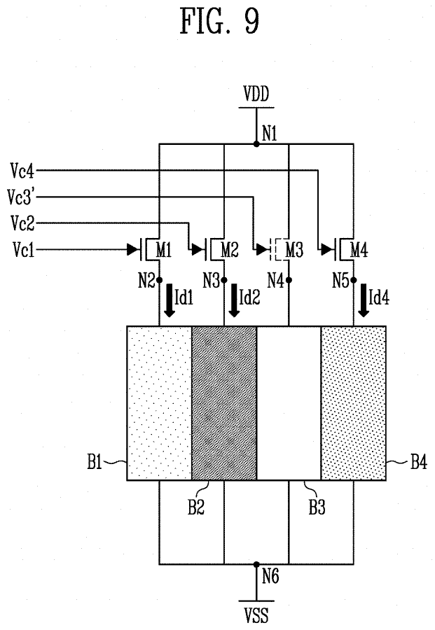

The block current controller 90 may receive sensing values respectively corresponding to sensed block currents and detect a deterioration block based on the block grayscale values and the sensing values. Detailed description thereof will be described later with reference to FIGS. 8 and 9.

When the deterioration block is detected, the block current controller 90 may output a control voltage for adjusting the block current to a control line CL. Here, the control voltage may mean a voltage for controlling the block currents corresponding to the blocks, respectively. Here, the number of the control line CL may be one or more, and each of the plurality of control lines CL may be connected to gate electrodes of the respective transistors included in the power interface 70 as described later.

Controlling the block current may mean that the block current is reduced or cut off. Detailed description thereof will be described later with reference to FIGS. 8 to 9.

As disclosed in the present embodiment, the timing controller 10 and the block current controller 90 may be separately configured. However, in another embodiment, the timing controller 10 and the block current controller 90 may be integrally formed.

Although not shown, the display device 1 may further include a memory.

Hereinafter, an embodiment of the display circuit 40 included in the display device 1 shown in FIG. 1 will be described.

FIG. 2 is a diagram illustrating an embodiment in which the pixels included in the display circuit 40 are divided into the plurality of blocks according to an embodiment of the disclosure.

In FIG. 2, four blocks are shown for convenience of description, as an example.

Referring to FIGS. 1 and 2, the pixels PXij included in the display circuit 40 according to an embodiment may be divided into a plurality of blocks B1, B2, B3, and B4.

The block is for defining a control unit for a plurality of pixels, is a virtual element, and is not a physical component. The blocks may be written to the memory to be defined in a manufacturing process or may be actively redefined in a process of using the product.

In an embodiment, for example, a first pixel PX1 of the pixels PXij may be included in a first block B1, a second pixel PX2 of the pixels PXij may be included in a second block B2, a third pixel PX3 of the pixels PXij may be included in a third block B3, and a fourth pixel PX4 of the pixels PXij may be included in a fourth block B4.

As an embodiment, the block grayscale values may be the sum of the grayscale values of the plurality of pixels included in the specific block. For example, a first block grayscale value may be a sum of grayscale values of a plurality of pixels (for example, the first pixel PX1) included in the first block B1, a second block grayscale value may be a sum of grayscale values of a plurality of pixels (for example, the second pixel PX2) included in the second block B2, a third block grayscale value may be a sum of grayscale values of a plurality of pixels (for example, the third pixel PX3) included in the third block B3, and a fourth block grayscale value may be a sum of grayscale values of a plurality of pixels (for example, the fourth pixel PX4) included in the fourth block B4.

Each of the blocks B1, B2, B3, and B4 may include pixels of the same number, and the blocks B1, B2, B3, and B4 may not overlap each other. In another embodiment, the blocks B1, B2, B3, and B4 may include pixels of different numbers. In still another embodiment, the blocks B1, B2, B3, and B4 may share (that is, overlap) at least some pixels.

Although not shown, as described later, power supply lines may be disposed for each of the blocks.

FIGS. 3 and 4 are circuit diagrams for describing a method of driving the pixel according to an embodiment of the disclosure.

Referring to FIG. 3, the pixel PXij may include transistors T1, T2, and T3, a storage capacitor Cst, and a light emitting diode LD.

In an embodiment, the transistors T1, T2, and T3 may be configured of P-type transistors. In another embodiment, the transistors T1, T2, and T3 may be configured of N-type transistors. In still another embodiment, the transistors T1, T2, and T3 may be configured of a combination of an N-type transistor and a P-type transistor.

The P-type transistor comprehensively refers to a transistor in which a conducted current amount increases when a voltage difference between a gate electrode and a source electrode increases in a negative direction. The N-type transistor comprehensively refers to a transistor in which conducted current amount increases when a voltage difference between a gate electrode and a source electrode increases in a positive direction. The transistor may be configured in various forms such as a thin film transistor (TFT), a field effect transistor (FET), and a bipolar junction transistor (BJT).

Hereinafter, for convenience of description, the transistors T1, T2, and T3 are shown as the N-type transistors.

The first transistor T1 may control the above-described driving current based on the data voltage (or the data signal). A gate electrode of the first transistor T1 may be connected to a first node N1, a first electrode of the first transistor T1 may be connected to the first power supply line PL1, and the second electrode of the first transistor T1 may be connected to a second node N2. The first transistor T1 may be referred to as a driving transistor. The first power supply line PL1 among power supply lines may be connected to the first power supply VDD, and the voltage of the first power supply VDD may be supplied to the first electrode of the first transistor T1 through the first power supply line PL1.

The second transistor T2 may be turned-on to select the pixel PXij when a first scan signal having a pulse of a turn-on level is supplied to the first scan line SLi1. A gate electrode of the second transistor T2 may be connected to the first scan line SLi1, a first electrode of the second transistor T2 may be connected to the data line DLj, and a second electrode of the second transistor T2 may be connected to the first node N1. The second transistor T2 may be referred to as a scanning transistor.

The third transistor T3 may be turned-on to supply sensing signals to the sensing line ILk when a second scan signal having a pulse of a turn-on level is supplied to the second scan line SLi2. A gate electrode of the third transistor T3 may be connected to the second scan line SLi2, a first electrode of the third transistor T3 may be connected to the second node N2, and a second electrode of the third transistor T3 may be connected to the sensing line ILk. Here, the sensing line ILk may be connected to an initialization power (not shown).

The storage capacitor Cst may charge a charge amount corresponding to a potential difference between a voltage of the first node N1 and a voltage of the second node N2. A first electrode of the storage capacitor Cst may be connected to the first node N1, and a second electrode of the storage capacitor Cst may be connected to the second node N2.

The light emitting diode LD may emit light at a predetermined luminance. An anode of the light emitting diode LD may be connected to the second node N2, and a cathode of the light emitting diode LD may be connected to the second power supply line PL2. The second power supply line PL2 of the power supply lines may be connected to the second power supply VSS, and the voltage of the second power supply VSS may be supplied to the cathode of the light emitting diode LD through the second power supply line PL2.

In general, the voltage of the first power supply VDD may be greater than the voltage of the second power supply VSS. However, in a special situation such as a situation in which light emission of the light emitting diode LD is prevented, the voltage of the second power supply VSS may be set to be greater than the voltage of the first power supply VDD.

During the display period, the voltage of the first power supply VDD may be greater than the voltage of the second power supply VSS. In addition, the data voltages may be sequentially applied to the data line DLj by a horizontal period unit. A scan signal of a turn-on level (for example, a high level) may be applied to the first scan line SLi1 in a corresponding horizontal period. In addition, a scan signal of a turn-off level (for example, a low level) may be applied to the second scan line SLi2 in synchronization with the first scan line SLi1, or a scan signal of a turn-off level may be continuously applied to the second scan line SLi2 during the display period.

In an embodiment, for example, when scan signal of a turn-on level is applied to the first scan line SLi1 and a scan signal of a turn-off level is applied to the second scan line SLi2, the second transistor T2 may be turned-on and the third transistor T3 may be turned-off. Therefore, a voltage difference between a data voltage applied to the first node N1 and a voltage corresponding to the second node N2 is written to the storage capacitor Cst of the pixel PXij.

In the pixel PXij, according to a voltage difference between the gate electrode and a source electrode (for example, the second electrode of the first transistor T1) of the first transistor T1, a driving current idpx flows through a driving path connecting the first power supply VDD, the first power supply line PL1, the first transistor T1, the light emitting diode LD, the second power supply line PL2, and the second power supply VSS. In addition, a light emission luminance of the light emitting diode LD may be determined according to the driving current idpx.

Thereafter, when a scan signal of a turn-off level is applied to the first scan line SLi1 and the second scan line SLi2, the second transistor T2 and the third transistor T3 may be turned-off. Therefore, regardless of a voltage change of the data line DLj, the voltage difference between the gate electrode and the source electrode of the first transistor T1 may be maintained by the storage capacitor Cst, and the light emission luminance of the light emitting diode LD may be maintained.

When the pixel PXij is included in a specific block, similarly to the pixel PXij, driving currents may respectively flow through the remaining pixels other than the pixel PXij among the pixels included in the specific block, light emitting elements included in the remaining pixels also emit light, and thus an image may be displayed in a specific block unit. At this time, a sum of the driving currents respectively flowing through the pixels included in the specific block may be approximated to the block current.

Referring to FIG. 4, in an embodiment, during the sensing period, in order to prevent the light emission of the light emitting diode LD, a voltage applied to the second power supply line PL2 (or the cathode of the light emitting diode LD connected to the second power supply line PL2) may be set to be greater than the voltage of the first power supply VDD. In another embodiment, the voltage of the second power supply VSS may be set to be greater than the voltage of the first power supply VDD during the sensing period. In addition, a sensing voltage (not shown) may be applied to the data line DLj. In addition, when the scan signals of the turn-on level are applied to the first scan line SLi1 and the second scan line SLi2 in synchronization with the sensing voltage, the second transistor T2 and the third transistor T3 may be turned-on. Here, an initialization voltage (not shown) may be applied to the second node N2 through the sensing line ILk before the sensing voltage is applied to the data line DLj.

When the sensing voltage is applied to the first node N1 of the pixel PXij and the first transistor T1 is turned-on, a sensing current ispx flows through a sensing path connecting the first power supply VDD, the first power supply line PL1, the first transistor T1, and the third transistor T3.

When the pixel PXij is included in a specific block, sensing currents may respectively flow through the remaining pixels other than the pixel PXij among the pixels included in the specific block in the sensing period as described above. Here, a sum of the sensing currents respectively flowing through the pixels included in the specific block may be approximated to the block current.

The pixel PXij may be a sub pixel of any one of red, green, and blue, or a unit pixel (or dot) including sub pixels of red, green, and blue. When the pixel PXij includes three different sub pixels, an emission combination of the sub pixels included in the pixel PXij in a specific pattern may be white.

The pixel PXij shown in FIGS. 3 and 4 is exemplary, and embodiments of the pixel PXij shown in FIGS. 3 and 4 may be applied to pixels of another circuit. For example, pixels having more complex circuit may further receive an emission control signal, and thus an emission period may be adjusted.

Hereinafter, embodiments of the power interface 70 included in the display device 1 according to an embodiment of the disclosure will be described in detail. Hereinafter, similarly to FIG. 4, four first power supply lines and four second power supply lines corresponding to the four blocks will be shown for the convenience of description.

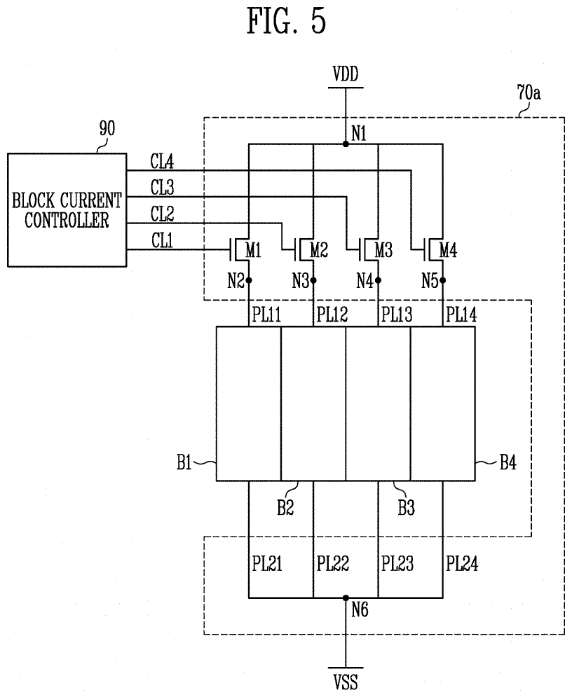

FIG. 5 is a diagram for describing an embodiment of the power interface included in the display device shown in FIG. 1.

In FIG. 5, four transistors and four control lines are shown for convenience of description.

Referring to FIG. 5, the power interface 70a according to an embodiment may include a plurality of transistors M1, M2, M3, and M4.

The first transistor M1 may control a first block current I1 provided to the first block B1. A first electrode of the first transistor M1 may be connected to a first node N1, the second electrode of the first transistor M1 may be connected to a second node N2, and a gate electrode of the first transistor M1 may be connected to a control line CL1.

The second transistor M2 may control a second block current I2 provided to the second block B2. A first electrode of the second transistor M2 may be connected to the first node N1, a second electrode of the second transistor M2 may be connected to a third node N3, and a gate electrode of the second transistor M2 may be connected to a control line CL2.

The third transistor M3 may control a third block current I3 provided to the third block B3. A first electrode of the third transistor M3 may be connected to the first node N1, a second electrode of the third transistor M3 may be connected to a fourth node N4, and a gate electrode of the third transistor M3 may be connected to a control line CL3.

The fourth transistor M4 may control the fourth block current I4 provided to the fourth block B4. A first electrode of the fourth transistor M4 may be connected to the first node N1, a second electrode of the fourth transistor M4 may be connected to a fifth node N5, and a gate electrode of the fourth transistor M4 may be connected to a control line CL4.

The first power supply VDD may be connected to the first node N1, a first power supply line PL11 may be connected to the second node N2, a first power supply line PL12 may be connected to the third node N3, a first power supply line PL13 may be connected to the fourth node N4, and a first power supply line PL14 may be connected to the fifth node N5. The first power supply lines PL11 to PL14 may be connected to each other outside the power interface 70a. For example, the first power supply lines PL11 to PL14 may be connected to each other in the display circuit 40.

Each of a plurality of second power supply lines PL21, PL22, PL23, and PL24 may be connected to a sixth node N6. In addition, the second power supply VSS may be connected to the sixth node N6. The second power supply lines PL21, PL22, PL23, and PL24 may be connected to each other outside the power interface 70a. For example, the second power supply lines PL21, PL22, PL23, and PL24 may be connected to each other in the display circuit 40. For example, the second power supply lines PL21, PL22, PL23, and PL24 may be commonly connected to a metal plate in the display circuit 40.

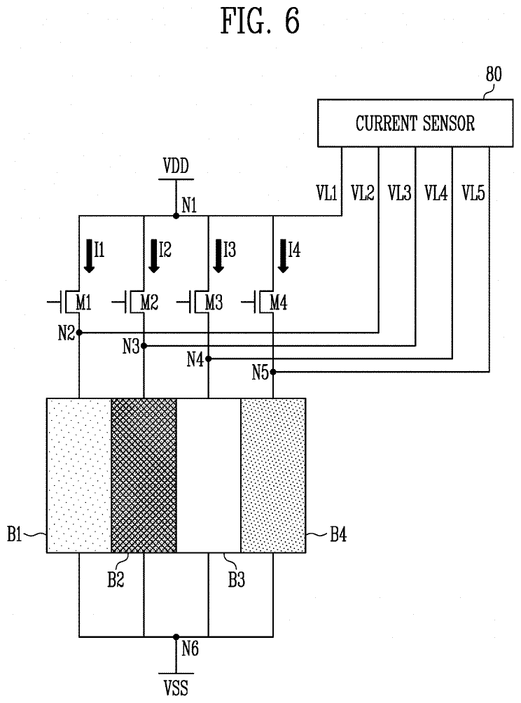

FIG. 6 is a diagram for describing an embodiment in which the current sensor senses the block current, and FIG. 7 is a diagram for describing an embodiment in which the resistance value of the equivalent resistor of the turned-on transistor is calculated.

In FIGS. 6 and 7, similarly to FIG. 5, four transistors and four control lines are shown for convenience of description.

The power interface 70a according to an embodiment may output block currents I1, I2, I3, and I4 to the first power supply lines PL11, PL12, PL13, and PL14, respectively, based on the first power supply VDD and the control voltage output from the block current controller 90.

Here, the block current may mean a current flowing through the transistor included in the power interface 70a. For example, a first block current I1 may be a current flowing through a turned-on first transistor M1, a second block current I2 may be a current flowing through a turned-on second transistor M2, a third block current I3 may be a current flowing through a turned-on third transistor M3, and a fourth block current I4 may be a current flowing through a turned-on fourth transistor M4.

Referring to FIGS. 5 and 6, for example, when the block current controller 90 outputs control voltages of a turn-on level to the control lines CL1, CL2, CL3, and CL4, respectively, and the control voltages of the turn-on level are applied to the respective gate electrodes of the transistors M1, M2, M3, and M4, the transistors M1, M2, M3, and M4 are turned-on.

When the transistors M1, M2, M3, and M4 are turned-on, the block currents I1, I2, I3, and I4 flow as described above with reference to FIGS. 2 and 3. Here, the block currents I1, I2, I3, and I4 are supplied to the display circuit 40 through the first power supply lines PL11, PL12, PL13, and PL14, respectively. In addition, since the pixels PXij included in the blocks B1, B2, B3, and B4 emit light at a required luminance, the blocks B1, B2, B3, and B4 display an image at a grayscale corresponding to respective block grayscale values thereof.

Here, the block grayscale value may be any one of a representative value of the grayscale values of the respective pixels included in the block, a sum of the grayscale values of the respective pixels included in the block, and an average value of the sum of the grayscale values of the respective pixels included in the block. Hereinafter, for convenience of description, it is assumed that the block grayscale value is the sum of the grayscale values of the respective pixels included in the block.

Here, when the block grayscale value is large (high), the block current according to the block grayscale value may also be large. Referring to FIGS. 4 and 6, for example, when the third block grayscale value of the third block B3 is the highest grayscale (for example, a white grayscale), and the first block grayscale value of the first block B1, the second block grayscale value of the second block B2, and the fourth block grayscale value of the fourth block B4 are grayscale values between the lowest grayscale value (for example, a black grayscale) and the highest grayscale value (for example, the white grayscale), since the pixel (for example, a third pixel PX3) included in the third block B3 emit light at a grayscale value corresponding to the third grayscale value, which is the highest grayscale value, and the pixels (for example, a first pixel PX1, a second pixel PX2, and a fourth pixel PX4) included in the respective first block B1, second block B2, and fourth block B4 emit light at a grayscale value between the lowest grayscale value (for example, the block grayscale) and the highest grayscale value (for example, the white grayscale), a third block current I3 of the third block B3 may be the largest among the block currents I1, I2, I3, and I4.

The block currents I1, I2, I3, and I4 supplied to the blocks B1, B2, B3, and B4, respectively, may flow to the second power supply VSS through the respective second power supply lines PL21, PL22, PL23, and PL24.

The current sensor 80 may sense the block currents I1, I2, I3, and I4 through measurement lines VL1, VL2, VL3, and VL4.

In an embodiment, for example, the current sensor 80 may sense the first block current I1 controlled by driving of the first transistor M1 through the measurement line VL1 connected to the first node N1 and the measurement line VL2 connected to the second node N2.

In an embodiment, for example, the current sensor 80 may sense the second block current I2 controlled by driving of the second transistor M2 through the measurement line VL1 connected to the first node N1 and the measurement line VL3 connected to the third node N3.

In an embodiment, for example, the current sensor 80 may sense the third block current I3 controlled by driving of the third transistor M3 through the measurement line VL1 connected to the first node N1 and the measurement line VL4 connected to the fourth node N4.

In an embodiment, for example, the current sensor 80 may sense the fourth block current I4 generated by driving of the fourth transistor M4 through the measurement line VL1 connected to the first node N1 and a measurement line VL5 connected to the fifth node N5.

The current sensor 80 may output sensing values corresponding to the sensed block currents I1, I2, I3, and I4, respectively. Here, the current sensor 80 may output a current as the sensing value by measuring a potential difference between both terminals of a sensing resistor required for sensing the current. Here, since the turned-on transistors M1, M2, M3, and M4 may be expressed by an equivalent resistor, there is an advantage that the turned-on transistors M1, M2, M3, and M4 corresponding to the equivalent resistor may be replaced with a sensing resistor. That is, the current sensor 80 may output the sensing value corresponding to the block current (any one of I1, I2, I3, and I4) based on a potential difference between a first electrode and a second electrode of the turned-on transistor (any one of M1, M2, M3, and M4) and a resistance value of the equivalent resistor (any one of M1, M2, M3, and M4).

In an embodiment, for example, the current sensor 80 may output a first sensing value corresponding to the first block current I1 based on the potential difference between the first electrode and the second electrode of the turned-on first transistor M1 and the resistance value of the equivalent resistor of the turned-on first transistor M1. However, the disclosure is not limited thereto, and the above-described embodiment may be similarly applied to the second transistor M2, the third transistor M3, and the fourth transistor M4.

In an embodiment, the sensing value may be calculated as a ratio of the potential difference between the first electrode and the second electrode of the turned-on transistor and the resistance value of the equivalent resistor of the turned-on transistor according to Ohm's law.

In order for the current sensor 80 to replace the turned-on transistor with the sensing resistor to calculate the sensing value, the resistance value of the equivalent resistor for each of the turned-on transistors M1, M2, M3, and M4 is required.

In an embodiment, for example, the resistance value of the equivalent resistor may be calculated based on a potential difference of the equivalent resistor measured when a reference control voltage of a turn-on level is input to the gate electrode and the transistor is turned-on, and a reference current corresponding to a preset reference block grayscale value.

Specifically, when a reference pattern is displayed on the display circuit 40, reference block grayscale values of the respective blocks B1, B2, B3, and B4 may also be calculated to display the reference pattern, and reference current values for respective reference currents It1, It2, It3, and It4 for the pixels included in the respective blocks B1, B2, B3, and B4 to emit light at a grayscale corresponding to the reference block grayscale value may also be calculated.

When reference voltages of a turn-on level are provided to the gate electrodes of the respective transistors M1, M2, M3, and M4, the transistors M1, M2, M3, and M4 are turned-on. When the potential differences of the equivalent resistors corresponding to the respective turned-on transistors M1, M2, M3, and M4 are measured, the resistance value of the equivalent resistor for the turned-on transistor may be calculated for each of the turned-on transistors M1, M2, M3, and M4 using the potential difference and the reference current value. Here, the reference pattern may be, for example, a full-white pattern in which all pixels included in the display circuit 40 emit light at the highest grayscale, and the reference block grayscale value may be the highest grayscale (or the white grayscale). Each of the reference currents It1, It2, It3, and It4 may mean a current corresponding to a sum of currents for a plurality of pixels included in each of the blocks B1, B2, B3, and B4 to emit light at the highest grayscale (for example, the white grayscale). In addition, the reference current value may mean a digital value of the reference current. However, the disclosure is not limited thereto.

Referring to FIGS. 6 and 7, for example, when the reference pattern is a full-white pattern, since all pixels included in the blocks B1, B2, B3, and B4 emit light at the highest grayscale, all of reference block grayscale values of the respective blocks B1, B2, B3, and B4 may also be calculated as the highest grayscale. Here, reference currents It1, It2, It3, and It4 corresponding to the reference block grayscale value, which is the highest grayscale, may also be calculated.

When the block current controller 90 supplies a reference control voltage of a turn-on to the gate electrode of the transistor (for example, M1), the transistor (for example, M1) may be turned-on and the turned-on transistor (for example, M1) may be represented by an equivalent resistor (for example, Rdson1). In addition, when the full-white pattern is displayed on the display circuit 40 (for example, the blocks B1, B2, B3, and B4), the current sensor 80 may measure a potential difference (for example, Vt1) of the equivalent resistor (for example, Rdsonl). Next, the current sensor 80 may calculate a resistance value of the equivalent resistor (for example, Rdson1) as a ratio of the potential difference (for example, Vt1) to the reference current (for example, It1) (or reference current value) corresponding to the block current according to Ohm's law. The above-described example is an embodiment based on a first equivalent resistor Rdsonl of the turned-on first transistor M1, but is not limited thereto. Respective resistance values of other equivalent resistors Rdson2, Rdson3, and Rdson4 may also be calculated similarly as described above.

The resistance values of the equivalent resistors Rdson1, Rdson2, Rdson3, and Rdson4 calculated as described above may be written to a memory to be defined in a manufacturing process, or may be actively redefined in the process of using the product.

According to the embodiment described above, there is an effect that the block current may be sensed using only a transistor without a separate sensing resistor.

In addition, according to the embodiment described above, there is an effect that manufacturing cost may be reduced by sensing the block current without adding a separate sensing resistor.

FIG. 8 is a diagram for describing an embodiment in which the deterioration block is detected.

In FIG. 8, similarly to FIGS. 5 to 7, four transistors are shown for convenience of description.

Referring to FIGS. 1, 5, and 8, the block current controller 90 may output control voltages Vc1, Vc2, Vc3, and Vc4 of a turn-on level to the control lines CL1, CL2, CL3, and CL4, respectively. In addition, when the transistors M1, M2, M3, and M4 are turned-on by the control voltages Vc1, Vc2, Vc3, and Vc4, block driving currents Id1, Id2, Id3, and Id4 may be provided to the display circuit 40. Here, each of the block driving currents Id1, Id2, Id3, and Id4 shown in FIG. 8 may mean a current corresponding to a sum of currents for a plurality of respective pixels included in each of the blocks B1, B2, B3, and B4 to emit light at a required luminance).

In an embodiment, for example, when the block current controller 90 outputs a first control voltage Vc1 of a turn-on level to the control line CL1, and the first control voltage Vc1 is supplied to the gate electrode of the first transistor M1, the first transistor M1 may be turned-on, and a first block driving current Id1 approximately corresponding to a sum of driving currents of the pixels included in the first block B1 may be supplied to the first block B1.

As the block driving currents Id1, Id2, Id3, and Id4 are provided to the blocks B1, B2, B3, and B4, respectively, the display circuit 40 including the blocks B1, B2, B3, and B4 may display an image according to the image data.

When a block grayscale value of a specific block (for example, B3) is greater than each of the block grayscale values of other blocks B1, B2, and B4, a magnitude of a block driving current (for example, Id3) provided to the specific block (for example, B3) may be greater than any of the magnitudes of block driving currents Id1, Id2, and Id4 provided to the other blocks B1, B2, and B4.

In this case, when a relatively large block driving current (for example, Id3) is provided to a specific block (for example, B3), deterioration may occur in a region corresponding to the specific block (for example, B3). As described above, the specific block in which deterioration is expected to occur may be referred to as the deterioration block.

A block grayscale value of the deterioration block may be greater than each of block grayscale values of the remaining blocks other than the deterioration block in the blocks. As an embodiment, a sensing value (for example, a block current) obtained from the deterioration block may be greater than each of sensing values obtained from the remaining blocks. As another embodiment, the sensing value obtained from the deterioration block may be greater than a preset reference sensing value. Here, the reference sensing value may be written to the memory by an experiment or the like in a manufacturing process. However, the disclosure is not limited thereto, and the reference sensing value may be updated even after the manufacturing process.

As a difference between the block grayscale value of the specific block (for example, B3) and each of the block grayscale values of the other blocks B1, B2, and B4 increases, a difference between the magnitude of the block driving current (for example, Id3) provided to the specific block (for example, B3) and each of the magnitudes of the block driving currents Id1, Id2, and Id4 provided to the other blocks B1, B2, and B4 may increase. Since a deterioration phenomenon due to a current is proportional to square of a current value, deterioration occurring in the specific block (for example, B3) may be more concentrated.

Therefore, in order to prevent this, the block current (for example, the block driving current Id3) provided to the deterioration block (for example, B3) is required to be adjusted by controlling the control voltage (for example, Vc3) applied to the gate electrode of the transistor (for example, M3).

When all of the block grayscale values of the blocks B1, B2, B3, and B4 are relatively high, and thus the difference between the magnitudes of the block driving currents Id1, Id2, Id3, and Id4 is relatively small, since a probability of deterioration in a specific block is low, the block current controller 90 may start a detection operation of the deterioration block using a case where the sum of the block grayscale values is equal to or less than a preset reference grayscale value as a start condition. Here, the preset reference grayscale value may be written to the memory by experiments in a manufacturing process. However, the disclosure is not limited thereto, and the preset reference grayscale value may be updated even after the manufacturing process.

For example, the block current controller 90 adds all of a first block grayscale value of the first block B1, a second block grayscale value of the second block B2, a third block grayscale value of the third block B3, and a fourth block grayscale value of the fourth block B4, and compares the addition of the block grayscale values with the reference grayscale value. When the addition of the block grayscale values is equal to or less than the reference grayscale value, the block current controller 90 may start the detection operation of the deterioration block.

When the detection operation of the deterioration block is started, the block current controller 90 may compare the block grayscale values of the blocks B1, B2, B3, and B4. For example, the block current controller 90 may compare the first block grayscale value of the first block B1, the second block grayscale value of the second block B2, the third block grayscale value of the third block B3, and the fourth block grayscale value of the fourth block B4.

As shown in FIG. 8, when the pixels included in the third block B3 emit light at the highest grayscale, the third block grayscale value of the third block B3 may be greater than any of the block grayscale values of the other blocks B1, B2, and B4. In this case, the block current controller 90 may write information on the third block B3 to the memory.

When the information on the third block B3 is stored, the block current controller 90 receives the sensing values for the block driving currents Id1, Id2, Id3, and Id4 sensed from the current sensor 80 and compares the sensing values for the driving currents Id1, Id2, Id3, and Id4. In addition, when the sensing value for the third block driving current Id3 provided to the third block B3 is greater than any of the block driving currents Id1, Id2, and Id4 provided to the other blocks B1, B2, and B4, the block current controller 90 may detect the third block B3 as the deterioration block.

FIG. 9 is a diagram for describing embodiments in which the block current supplied to the detected deterioration block is adjusted.

In FIG. 9, similarly to FIGS. 5 to 8, four transistors and four control voltages are shown for convenience of description.

Referring to FIGS. 8 and 9, when the deterioration block (for example, the third block B3) is detected, the block current controller 90 changes the control voltage applied to the gate electrode of the transistor (for example, the third transistor M3) corresponding to the deterioration block (for example, the third block B3), and supplies the changed control voltage to the gate electrode of the transistor (for example, the third transistor M3) corresponding to the deterioration block (for example, the third block B3). Here, the control voltage for adjusting the block current supplied to the deterioration block may be a voltage of a turn-off level at which the transistor corresponding to the deterioration block is turned-off. For example, a third control voltage Vc3′ may be a voltage of a turn-off level capable of turning-off the third transistor M3.

When the third control voltage Vc3′ shown in FIG. 9 is applied to the gate electrode of the third transistor M3, the third transistor M3 may be turned-off, and the block current (for example, the third block driving current Id3) may not flow through the third transistor M3.

Although not shown, since the first power supply lines PL11, PL12, PL13, and PL14 and the second power supply lines PL21, PL22, PL23, and PL24 may be connected respectively in the display circuit 40, some of the block currents provided to blocks adjacent to the deterioration block may flow through the pixels included in the deterioration block in the display circuit 40, and thus each of the pixels corresponding to the deterioration block may emit light at a required luminance.

The block current controller 90 may determine a change amount of the block current (for example, the third block driving current Id3) provided to the deterioration block (for example, the third block B3) based on a change amount of the control voltage applied to the gate electrode of the transistor (for example, the third transistor M3) corresponding to the deterioration block (for example, the third block B3). At this time, different from that of FIG. 9, the third control voltage Vc3′ is a voltage of a turn-on level that maintains a turn-on state of the third transistor M3. However, the third control voltage Vc3′ may be a voltage lower than the third control voltage Vc3 shown in FIG. 8 (when the third transistor M3 is an NMOS). The change amount of the control voltage at this time may be a change amount corresponding to a difference value between the third control voltage Vc3 and the third control voltage Vc3′.

Although not clearly shown, in an embodiment, the block current controller 90 may calculate the change amount of the control voltage based on a first difference between the block grayscale value of the deterioration block and any one of the block grayscale values of the remaining blocks. Here, the any one of the block grayscale values may be the smallest minimum block grayscale value among the block grayscale values of the remaining blocks.

Specifically, for example, when the block having the minimum block grayscale value among the blocks B1, B2, B3, and B4 shown in FIG. 8 is the second block B2, the block current controller 90 calculates a first difference value between the third block grayscale value of the third block B3 which is the deterioration block and the second block grayscale value of the second block B2, corrects the third control voltage Vc3 by reflecting the first difference value to the third control voltage Vc3 shown in FIG. 8, and applies the corrected third control voltage Vc3′ to the gate electrode of the third transistor M3. Here, the larger the first difference value, the smaller the corrected third control voltage Vc3′ (when the third transistor M3 is the NMOS).

When the corrected third control voltage Vc3′ is applied to the gate electrode of the third transistor M3, a changed third block driving current may be provided to the third block B3. Here, the corrected third control voltage Vc3′ may be smaller than the third control voltage Vc3 shown in FIG. 8 (when the third transistor M3 is the NMOS).

Although not clearly shown, in another embodiment, the block current controller 90 may calculate the change amount of the control voltage based on a second difference between the sensing value of the deterioration block and the sensing value of any one of the remaining blocks. Here, the any one sensing value may be the smallest minimum sensing value among the sensing values of the remaining blocks.

Specifically, for example, when the block having the minimum sensing value among the blocks B1, B2, B3, and B4 shown in FIG. 8 is the second block B2, the block current controller 90 calculates the second difference value of the sensing value (for example, a sensing value corresponding to the third block driving current Id3 shown in FIG. 8) of the third block B3, which is the deterioration block and a sensing value (for example, a sensing value corresponding to the second block driving current Id2 shown in FIG. 8) of the second block B2, corrects the third control voltage Vc3 by reflecting the second difference value to the third control voltage Vc3 shown in FIG. 8, and applies the corrected third control voltage Vc3′ to the gate electrode of the third transistor M3. Here, the larger the second difference value, the smaller the corrected third control voltage Vc3′ (when the third transistor M3 is the NMOS).

In still another embodiment, the block current controller 90 may calculate the change amount of the control voltage based on the first difference value between the block grayscale value of the deterioration block and the block grayscale value of any one of the block grayscale values of the remaining blocks, and the second difference value between the sensing value of the deterioration block and the sensing value of any one of the sensing values of the remaining blocks.

Since the sensing value obtained from the deterioration block may be greater than the preset reference sensing value, the block current controller 90 may determine the change amount of the control voltage using a second difference value between the sensing value of the deterioration block and the reference sensing value, instead of the second difference value between the sensing value of the deterioration block and the sensing value of any one of the sensing values of the remaining blocks described above.

In an embodiment, for example, when the deterioration block is the third block B3, a second difference value between the sensing value of the third block B3 (for example, the sensing value corresponding to the third block driving current Id3 shown in FIG. 8) and the reference sensing value is calculated, the corrected third control voltage Vc3′ is calculated by reflecting the second difference value to the third control voltage Vc3 shown in FIG. 8, and the corrected third control voltage Vc3′ is applied to the gate electrode of the third transistor M3.

The above-described example is described with reference to the third block B3, but is not limited thereto. The above-described embodiment may also be applied to each of the other blocks B1, B2, and B4.

According to the embodiment described above, there is an effect that deterioration or a fire phenomenon of the pixels due to an overcurrent may be prevented.

In addition, there is an effect that a life of the display device 1 may be improved by minimizing the deterioration generated in the display circuit 40.

Instead of the resistance value for the equivalent resistor of the transistors M1, M2, M3, and M4, a sensing resistor used to sense a current may be used.

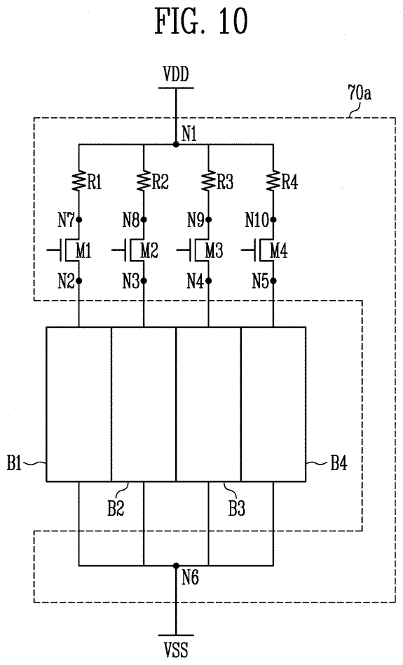

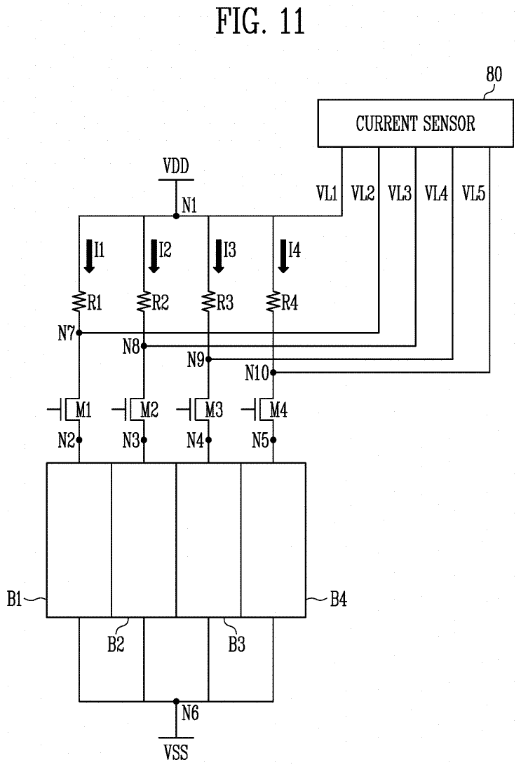

FIG. 10 is a diagram for describing an embodiment of a sensing resistor included in the power interface shown in FIG. 5, and FIG. 11 is a diagram for describing another embodiment in which the current sensor senses the block current.

In FIGS. 10 and 11, four sensing resistors are shown for convenience of description. In FIG. 10 and FIG. 11, the same reference numerals are assigned to the same components as those shown in FIG. 5 and detailed description thereof will be omitted.

Referring to FIG. 10, the power interface 70a may further include a plurality of sensing resistors R1, R2, R3, and R4.

Each of the sensing resistors R1, R2, R3, and R4 may be a resistor for sensing the block current. First terminals of the respective sensing resistors R1, R2, R3, and R4 may be connected to the first power supply VDD, and second terminals of the respective sensing resistors R1, R2, R3, and R4 may be connected to the first electrodes of the respective transistors M1, M2, M3, and M4.

In an embodiment, for example, the first terminal of the first sensing resistor R1 may be connected to a first node N1, and the second terminal of the first sensing resistor R1 may be connected to a seventh node N7. Here, the first power supply VDD may be connected to the first node N1, and the first electrode of the first transistor M1 may be connected to the seventh node N7.

For example, the first terminal of the second sensing resistor R2 may be connected to the first node N1, and the second terminal of the second sensing resistor R2 may be connected to an eighth node N8. Here, the first power supply VDD may be connected to the first node N1, and the first electrode of the second transistor M2 may be connected to the eighth node N8.

For example, the first terminal of the third sensing resistor R3 may be connected to the first node N1, and the second terminal of the third sensing resistor R3 may be connected to a ninth node N9. Here, the first power supply VDD may be connected to the first node N1, and the first electrode of the third transistor M3 may be connected to the ninth node N9.

For example, the first terminal of the fourth sensing resistor R4 may be connected to the first node N1, and the second terminal of the fourth sensing resistor R4 may be connected to a tenth node N10. Here, the first power supply VDD may be connected to the first node N1, and the first electrode of the fourth transistor M4 may be connected to the tenth node N10.

Here, resistance values of the respective first sensing resistor R1, second sensing resistor R2, third sensing resistor R3, and fourth sensing resistor R4 may be written to the memory in a manufacturing process, and may be the same value or different values.

Referring to FIGS. 10 and 11, when the sensing resistors R1, R2, R3, and R4 are included in the power interface 70a, the respective measurement lines VL1, VL2, VL3, VL4 and VL5 may be connected to both terminals of the respective sensing resistors R1, R2, R3, R4, the current sensor 80 may measure a potential difference between the both terminals of each of the respective sensing resistors R1, R2, R3, R4, and may calculate the sensing values corresponding to the block currents I1, I2, I3, and I4 using the potential differences and the resistance values of the respective sensing resistors R1, R2, R3, and R4.

That is, the sensing values may be calculated based on potential differences between a voltage of a node (for example, the first node N1) to which the first terminal of the respective sensing resistors R1, R2, R3, and R4 is connected and voltages of respective nodes (for example, the seventh node N7, the eighth node N8, the ninth node N9, and the tenth node N10) to which the second terminals of the respective sensing resistors R1, R2, R3, and R4 are connected, and the resistance values of the respective sensing resistors R1, R2, R3, and R4.

For example, the current sensor 80 may calculate the sensing value corresponding to the first block current I1 by measuring the potential difference of the first sensing resistor R1 through a measurement line VL1 connected to the first node N1 and a measurement line VL2 connected to the seventh node N7 and calculating a ratio of the potential difference to the resistance value of the first sensing resistor R1 according to Ohm's law.

For example, the current sensor 80 may calculate the sensing value corresponding to the second block current I2 by measuring the potential difference of the second sensing resistor R2 through the measurement line VL1 connected to the first node N1 and a measurement line VL3 connected to the eight node N8 and calculating a ratio of the potential difference to the resistance value of the second sensing resistor R2 according to Ohm's law.

For example, the current sensor 80 may calculate the sensing value corresponding to the third block current I3 by measuring the potential difference of the third sensing resistor R3 through the measurement line VL1 connected to the first node N1 and a measurement line VL4 connected to the ninth node N9 and calculating a ratio of the potential difference to the resistance value of the third sensing resistor R3 according to Ohm's law.

For example, the current sensor 80 may calculate the sensing value corresponding to the fourth block current I4 by measuring the potential difference of the fourth sensing resistor R4 through the measurement line VL1 connected to the first node N1 and a measurement line VL5 connected to the tenth node N10 and calculating a ratio of the potential difference to the resistance value of the fourth sensing resistor R4 according to Ohm's law.

According to the embodiment described above, the resistance values of the equivalent resistors for the transistors M1, M2, M3, and M4 are not written to the memory in a manufacturing process, and the block currents are measured by using a simple sensing resistor. Therefore, there is an effect that a use amount of the memory may be reduced and a calculation speed may be increased.

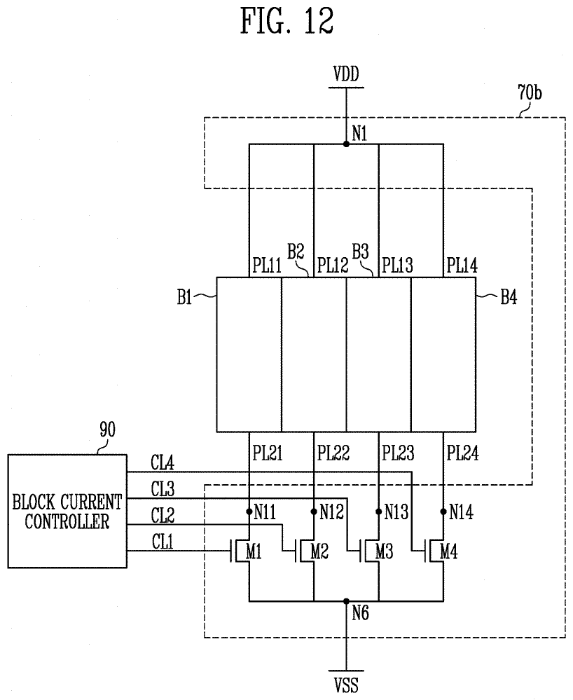

FIG. 12 is a diagram for describing another embodiment of the power interface included in the display device shown in FIG. 1.

In FIG. 12, the same reference numerals are assigned to the same components as those shown in FIG. 5, and detailed description thereof will be omitted. In addition, in FIG. 12, identically to FIG. 5, four blocks, four transistors, four first power supply lines, and four second power supply lines are shown for convenience of description.

Referring to FIG. 12, the power interface 70b according to another embodiment of the disclosure may include the plurality of transistors M1, M2, M3, and M4 identically to the power interface 70a shown in FIG. 5 except that a position where the transistors M1, M2, M3, and M4 shown in FIG. 12 are disposed and a position where the transistors M1, M2, M3, and M4 shown in FIG. 5 are disposed different from each other.

The first electrode of the first transistor M1 may be connected to the second power supply line PL21, the second electrode of the first transistor M1 may be connected to the sixth node N6, and the gate electrode of the first transistor M1 may be connected to the control line CL1.

The first electrode of the second transistor M2 may be connected to the second power supply line PL22, the second electrode of the second transistor M2 may be connected to the sixth node N6, and the gate electrode of the second transistor M2 may be connected to the control line CL2.

The first electrode of the third transistor M3 may be connected to the second power supply line PL23, the second electrode of the third transistor M3 may be connected to the sixth node N6, and the gate electrode of the third transistor M3 may be connected to the control line CL3.

The first electrode of the fourth transistor M4 may be connected to the second power supply line PL24, the second electrode of the fourth transistor M4 may be connected to the sixth node N6, and the gate electrode of the fourth transistor M4 may be connected to the control line CL4.

The second power supply line PL21 may be connected to an eleventh node N11, the second power supply line PL22 may be connected to a twelfth node N12, the second power supply line PL23 may be connected to a thirteenth node N13, and the second power supply line PL24 may be connected to a fourteenth node N14.

Each of the plurality of first power supply lines PL11, PL12, PL13, and PL14 may be connected to the first node N1. In addition, the second power supply VSS may be connected to the sixth node N6.

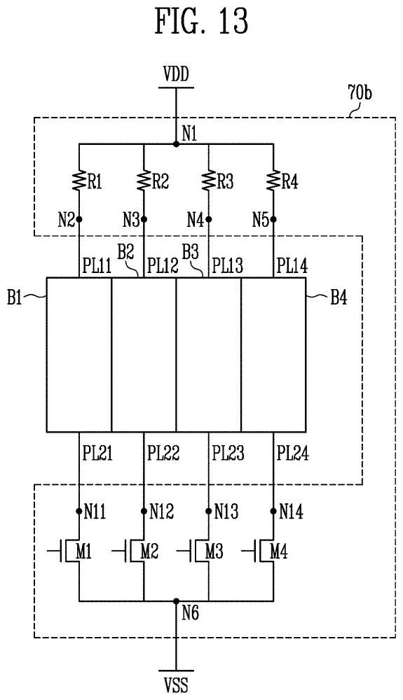

FIG. 13 is a diagram for describing an embodiment of the sensing resistor included in the power interface shown in FIG. 12.

Referring to FIG. 13, the power interface 70b shown in FIG. 12 may include the plurality of sensing resistors R1, R2, R3, and R4 identically to the power interface 70a shown in FIG. 5.

For example, the first sensing resistor R1 may be disposed between the first power supply line PL11 and the first power supply VDD, the first terminal of the first sensing resistor R1 may be connected to the first node N1, and the second terminal of the first sensing resistor R1 may be connected to the second node N2.

For example, the second sensing resistor R2 may be disposed between the first power supply line PL12 and the first power supply VDD, the first terminal of the second sensing resistor R2 may be connected to the first node N1, and the second terminal of the second sensing resistor R2 may be connected to the third node N3.

For example, the third sensing resistor R3 may be disposed between the first power supply line PL13 and the first power supply VDD, the first terminal of the third sensing resistor R3 may be connected to the first node N1, and the second terminal of the third sensing resistor R3 may be connected to the fourth node N4.

For example, the fourth sensing resistor R4 may be disposed between the first power supply line PL14 and the first power supply VDD, the first terminal of the fourth sensing resistor R4 may be connected to the first node N1, and the second terminal of the fourth sensing resistor R4 may be connected to the fifth node N5.

Since the description of the sensing resistors R1, R2, R3, and R4 shown in FIG. 13 is the same as described above with reference to FIG. 10, description thereof will be omitted.

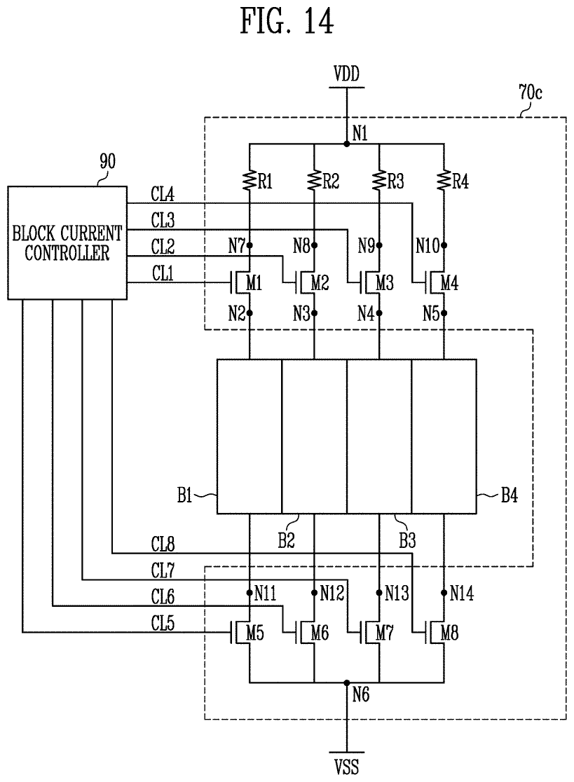

FIG. 14 is a diagram for describing still another embodiment of the power interface included in the display device shown in FIG. 1.

Referring to FIG. 14, the power interface 70c according to still another embodiment of the disclosure may have a structure similar to that of the power interface 70a shown in FIG. 10, and may further include transistors M5, M6, M7, and M8.

A first electrode of the fifth transistor M5 may be connected to an eleventh node N11, a second electrode of the fifth transistor M5 may be connected to a sixth node N6, and a gate electrode of the fifth transistor M5 may be connected to a control line CL5.

A first electrode of the sixth transistor M6 may be connected to a twelfth node N12, a second electrode of the sixth transistor M6 may be connected to the sixth node N6, and a gate electrode of the sixth transistor M6 may be connected to a control line CL6.

A first electrode of the seventh transistor M7 may be connected to a thirteenth node N13, a second electrode of the seventh transistor M7 may be connected to the sixth node N6, and a gate electrode of the seventh transistor M7 may be connected to a control line CL7.

A first electrode of the eighth transistor M8 may be connected to a fourteenth node N14, a second electrode of the eighth transistor M8 may be connected to the sixth node N6, and a gate electrode of the eighth transistor M8 may be connected to a control line CL8.

As shown in FIG. 13, the second power supply line PL21 may be connected to the eleventh node N11, the second power supply line PL22 may be connected to the twelfth node N12, the second power supply line PL23 may be connected to the thirteenth node N13, and the second power supply line PL24 may be connected to the fourteenth node N14.

The transistors M5, M6, M7, and M8 may be turned-on in the display period and may be turned-off in the sensing period. As an embodiment, each of the transistors M5, M6, M7, and M8 may be controlled by the block current controller 90. As another embodiment, each of the transistors M5, M6, M7, and M8 may be controlled by a configuration in which the block current controller 90 and the timing controller 10 are integrated. Each of the transistors M5, M6, M7, and M8 may be referred to as a sensing transistor. Hereinafter, an embodiment in which the transistors M5, M6, M7, and M8, which are sensing transistors, are driven in the sensing period will be described.

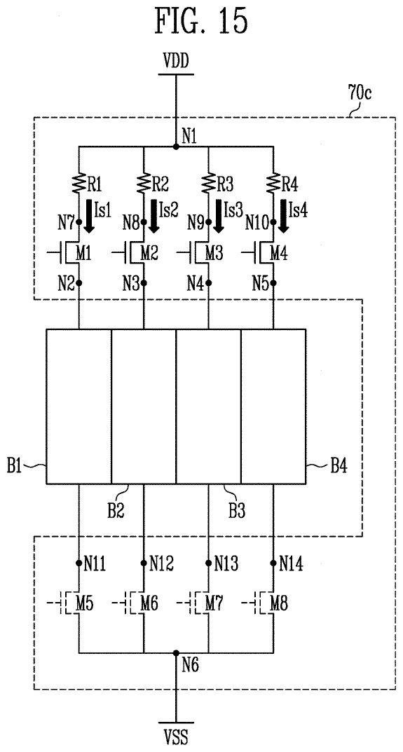

FIG. 15 is a diagram for describing an embodiment in which the power interface shown in FIG. 14 is driven in the sensing period.

Referring to FIG. 15, the transistors M5, M6, M7, and M8, which are sensing transistors, may receive control signals of a turn-off level through control lines and may be turned-off, in the sensing period.

In this case, although not shown, as described above with reference to FIG. 4, in order to prevent light emission of the light emitting diode LD included in each of the pixels PXij, a voltage applied to the second power supply lines (for example, PL21, PL22, PL23, and PL24 shown FIG. 13) may be higher than the voltage of the first power supply VDD.

Referring to FIG. 15, for example, a voltage applied to the eleventh node N11 to which the second power supply line PL21 and the first electrode of the fifth transistor M5 shown in FIG. 13 are connected may be higher than the voltage of the first power supply VDD.

Referring to FIG. 15, for example, a voltage applied to the twelfth node N12 to which the second power supply line PL22 and the first electrode of the sixth transistor M6 shown in FIG. 13 are connected may be higher than the voltage of the first power supply VDD.

Referring to FIG. 15, for example, a voltage applied to the thirteenth node N13 to which the second power supply line PL23 and the first electrode of the seventh transistor M7 shown in FIG. 13 are connected may be higher than the voltage of the first power supply VDD.

Referring to FIG. 15, for example, a voltage applied to the fourteenth node N14 to which the second power supply line PL24 and the first electrode of the eighth transistor M8 shown in FIG. 13 are connected may be higher than the voltage of the first power supply VDD.

When the transistors M5, M6, M7, and M8 are turned-off, sensing currents Is1, Is2, Is3, and Is4 may not flow to the second power supply VSS and may be provided to the sensing circuit 50. Therefore, the compensator 60 may calculate a compensation value.

Although the embodiments of the disclosure have been described with reference to the accompanying drawings, it will be understood by those skilled in the art to which the disclosure pertains that the embodiments may be implemented in other specific forms without changing the technical spirit and essential features of the disclosure. Therefore, it should be understood that the embodiments described above are illustrative and are not restrictive in all aspects.

What is claimed is:

1. A display device comprising:
a display circuit including pixels divided into a plurality of blocks;
a power interface which outputs block currents corresponding to the blocks to first power supply lines, respectively, based on a voltage of a first power supply and a control voltage;
a current sensor which senses the block currents and outputs sensing values of the block currents; and
a block current controller which calculates block grayscale values corresponding to the blocks, respectively, based on image data, detects a deterioration block based on the block grayscale values and the sensing values, and outputs the control voltage to a control line for controlling a block current supplied to the deterioration block,
wherein the power interface includes a plurality of transistors each including a first electrode connected to the first power supply, a second electrode connected to the first power supply line, and a gate electrode connected to the control line.

2. The display device according to claim 1, wherein the sensing value is calculated based on a potential difference between the first electrode and the second electrode of a turned-on transistor and a resistance value of an equivalent resistor of the turned-on transistor.

3. The display device according to claim 2, wherein, when the transistor is turned-on by a reference control voltage of a turn-on level, the resistance value is calculated based on a potential difference of the equivalent resistor of the turned-on transistor and a block current corresponding to a preset reference block grayscale value.

4. The display device according to claim 1, wherein a block grayscale value of the deterioration block is greater than any of block grayscale values of remaining blocks other than the deterioration block in the blocks, and
a sensing value obtained from the deterioration block is greater than sensing values obtained from the remaining blocks.

5. The display device according to claim 4, wherein a change amount of the block current provided to the deterioration block is determined based on a change amount of a control voltage applied to a gate electrode of a transistor corresponding to the deterioration block, and
the change amount of the control voltage is calculated based on at least one of a first difference value between the block grayscale value of the deterioration block and any one block grayscale value among the block grayscale values of the remaining blocks, and a second difference value between the sensing value of the deterioration block and any one sensing value among the sensing values of the remaining blocks.

6. The display device according to claim 5, wherein the any one block grayscale value is a smallest minimum block grayscale value among the block grayscale values of the remaining blocks, and
the any one sensing value is a smallest minimum sensing value among the sensing values of the remaining blocks.

7. The display device according to claim 1, wherein the block grayscale value of the deterioration block is greater than any of block grayscale values of remaining blocks other than the deterioration block in the blocks, and
the sensing value obtained from the deterioration block is greater than a preset reference sensing value.

8. The display device according to claim 7, wherein a change amount of the block current provided to the deterioration block is determined based on a change amount of a control voltage applied to a gate electrode of a transistor corresponding to the deterioration block, and
the change amount of the control voltage is calculated based on at least one of a first difference value between the block grayscale value of the deterioration block and any one block grayscale value among the block grayscale values of the remaining blocks, and a second difference value between the sensing value of the deterioration block and the reference sensing value.

9. The display device according to claim 1, wherein the block current controller starts a detection operation of the deterioration block using a case where a sum of the block grayscale values is equal to or less than a preset reference grayscale value as a start condition.

10. The display device according to claim 1, wherein the block grayscale value is any one of a representative value of grayscale values of the respective pixels included in the block, a sum of grayscale values of the respective pixels included in the block, and an average value of the sum of the grayscale values of the respective pixels included in the block.

11. The display device according to claim 1, wherein the control voltage controlling the block current supplied to the deterioration block is a voltage of a turn-off level at which a transistor corresponding to the deterioration block is turned-off.

12. The display device according to claim 1, wherein the power interface further includes a plurality of sensing resistors each having a first terminal connected to the first power supply and a second terminal connected to the first electrode of the transistor.

13. The display device according to claim 12, wherein the sensing values are calculated based on a potential difference between a voltage of a node connected to the first power supply and the first terminal and a voltage of a node connected to the first electrode and the second terminal, and a resistance value of the sensing resistor.

14. The display device according to claim 12, wherein the power interface further includes a plurality of sensing transistors each including a first electrode connected to a second power supply line different from the first power supply line, a second electrode connected to a second power supply having a voltage lower than a voltage of the first power supply, and a gate electrode connected to the control line.

15. The display device according to claim 14, wherein the sensing transistor receives a control signal of a turn-off level through the control line and is turned-off in a sensing period, and
a voltage applied to a node to which the second power supply line and the first electrode of the sensing transistor are connected is higher than the voltage of the first power supply. 15

16. A display device comprising:
a display circuit including pixels divided into a plurality of blocks;
a power interface which outputs block currents corresponding to the blocks to first power supply lines, respectively, based on a voltage of first power supply and a control voltage;
a current sensor which senses the block currents and output sensing values of the block currents; and
a block current controller which calculates block grayscale values corresponding to the blocks, respectively, based on image data, detects a deterioration block based on the block grayscale values and the sensing values, and outputs the control voltage to a control line for controlling a block current supplied to the deterioration block,
wherein the power interface includes a plurality of transistors each including a first electrode connected to a second power supply line, a second electrode connected to a second power supply having a voltage lower than the voltage of the first power supply, and a gate electrode connected to the control line.

17. The display device according to claim 16, wherein the sensing value is calculated based on a potential difference between the first electrode and the second electrode of a turned-on transistor and a resistance value of an equivalent resistor of the turned-on transistor.

18. The display device according to claim 17, wherein, when the transistor is turned-on by a reference control voltage of a turn-on level, the resistance value is calculated based on a potential difference of the equivalent resistor of the turned-on transistor and a reference current corresponding to a preset reference block grayscale value.

19. The display device according to claim 16, wherein a block grayscale value of the deterioration block is greater than any of block grayscale values of remaining blocks other than the deterioration block in the blocks, and
a sensing value obtained from the deterioration block is greater than any of sensing values obtained from the remaining blocks.

20. The display device according to claim 16, wherein the block current controller starts a detection operation of the deterioration block using a case where a sum of the block grayscale values is equal to or less than a preset reference grayscale value as a start condition.

21. The display device according to claim 16, wherein the control voltage controlling the block current supplied to the deterioration block is a voltage of a turn-off level at which a transistor corresponding to the deterioration block is turned-off.

22. The display device according to claim 16, wherein the power interface further includes a plurality of sensing resistors each having a first terminal connected to the first power supply and a second terminal connected to the first power supply line.
